(19) United States
(12) Patent Application Publication
(10) Pub. No.: US 2020/0302283 A1
(43) Pub. Date: Sep. 24, 2020

(54) MIXED PRECISION TRAINING OF AN ARTIFICIAL NEURAL NETWORK

(71) Applicant: Microsoft Technology Licensing, LLC, Redmond, WA (US)

(72) Inventors: Haishan ZHU, Bellevue, WA (US); Taesik NA, Issaquah, WA (US); Daniel LO, Bothell, WA (US); Eric S. CHUNG, Redmond, WA (US)

(21) Appl. No.: 16/357,139

(22) Filed: Mar. 18, 2019

(51) Int. Cl. G06N 3/08; G06N 3/04; G06F 7/483

(52) U.S. Cl. CPC G06N 3/08; G06F 7/483; G06N 3/0445

(57) ABSTRACT

The use of mixed precision values when training an artificial neural network (ANN) can increase performance while reducing cost. Certain portions and/or steps of an ANN may be selected to use higher or lower precision values when training. Additionally, or alternatively, early phases of training are accurate enough with lower levels of precision to quickly refine an ANN model, while higher levels of precision may be used to increase accuracy for later steps and epochs. Similarly, different gates of a long short-term memory (LSTM) may be supplied with values having different precisions.

### BACKGROUND

Artificial neural networks (“ANNs” or “NNs”) are applied to a number of applications in Artificial Intelligence (“AI”) and Machine Learning (“ML”), including image recognition, speech recognition, search engines, and other suitable applications. ANNs are typically trained across multiple “epochs.” In each epoch, an ANN trains over all of the training data in a training data set in multiple steps. In each step, the ANN first makes a prediction for an instance of the training data (which might also be referred to herein as a “sample”). This step is commonly referred to as a “forward pass” (which might also be referred to herein as a “forward training pass”), although a step may also include a backward pass.

To make a prediction, a training data sample is fed to the first layer of the ANN, which is commonly referred to as an “input layer.” Each layer of the ANN then computes a function over its inputs, often using learned parameters, or “weights,” to produce an input for the next layer. The output of the last layer, commonly referred to as the “output layer,” is a class prediction, commonly implemented as a vector indicating the probabilities that the sample is a member of a number of classes. Based on the label predicted by the ANN and the actual label of each instance of training data, the output layer computes a “loss,” or error function.

In a “backward pass” (which might also be referred to herein as a “backward training pass”) of the ANN, each layer of the ANN computes the error for the previous layer and the gradients, or updates, to the weights of the layer that move the ANN's prediction toward the desired output. The result of training a ANN is a set of weights, or “kernels,” that represent a transform function that can be applied to an input with the result being a classification, or semantically labeled output.

After an ANN is trained, the trained ANN can be used to classify new data. Specifically, a trained ANN model can use weights and biases computed during training to perform tasks (e.g. classification and recognition) on data other than that used to train the ANN. General purpose central processing units (“CPUs”), special purpose processors (e.g. graphics processing units (“GPUs”), tensor processing units (“TPUs”) and field-programmable gate arrays (“FPGAs”)), and other types of hardware can be used to execute an ANN model.

ANNs commonly use normal-precision floating-point formats (e.g. 16-bit, 32-bit, 64-bit, and 80-bit floating point formats) for internal computations. Training ANNs can be a very compute and storage intensive task, taking billions of operations and gigabytes of storage. Performance, energy usage, and storage requirements of ANNs can, however, be improved through the use of quantized-precision floating-point formats during training and/or inference. Examples of quantized-precision floating-point formats include formats having a reduced bit width (including by reducing the number of bits used to represent a number's mantissa and/or exponent) and block floating-point (“BFP”) formats that use a small (e.g. 3, 4, or 5-bit) mantissa and an exponent shared by two or more numbers. The use of quantized-precision floating-point formats can, however, have certain negative impacts on ANNs such as, but not limited to, a loss in accuracy.

It is with respect to these and other technical challenges that the disclosure made herein is presented.

### SUMMARY

Technologies are disclosed herein for mixed precision training. Through implementations of the disclosed technologies, the time needed to train and/or accuracy of ANNs can be improved by varying precision in different portions (e.g. different layers or other collection of neurons) of the ANN and/or during different training steps. Varying precision allows sensitive portions and/or steps to utilize higher precision weights, activations, etc., while less sensitive portions and/or steps may be satisfactorily processed using lower precision values.

Many technical benefits flow from the use of mixed precision training. For example, by maintaining or increasing precision for critical portions and/or steps of network training, greater accuracy is achieved. At the same time, use of lower precision values reduces storage and compute resources required to train the ANN.

Storage requirements are reduced by requiring fewer bits to store weights, activations, and other values used during ANN training. Compute resources are reduced in part by reducing the amount of time it takes to perform constituent operations. For example, activation functions such as sigmoid functions may be calculated in less time when the function's inputs have lower precision—i.e. when the parameters are described with fewer bits. The reduction in requirements of computing resources might also be caused in part by having fewer bits to process for a given operation, e.g. a multiplication operation takes less time when the operands have fewer bits.

Additionally, or alternatively, by using fewer bits to accomplish a given computation, computing resources are made available to increase performance in other ways, such as increasing levels of parallelization. Reductions in computing resources may be particularly pronounced when using custom circuits, such as an ASIC, FPGA, etc. In these configurations, the number of processing units (e.g. FPGA logic blocks) used to perform a given operation is smaller, as is the number of connections required to forward bits between logic blocks.

The reduction in the number of logic blocks and connections might be positively-correlated (e.g., scales linearly or super-linearly) to the reduction in the number of bits used to represent a lower-precision number. As a result, the circuits needed to process smaller bit-width formats are smaller, cheaper, faster, and more energy efficient. Other technical benefits can be realized through implementations of the disclosed technologies.

In order to provide the technical benefits mentioned above, and potentially others, certain portions and/or steps of an ANN may be selected to use higher or lower precision values when training. For example, an initial layer (i.e. the ‘input layer’) and a final layer (i.e. the ‘output layer’) of an ANN might be processed with higher levels of precision than other layers (i.e. ‘hidden layers’). Additionally, or alternatively, early phases of training might function with enough accuracy with lower levels of precision to quickly refine an ANN model, while higher levels of precision may be used to increase accuracy for later steps and epochs.

In some configurations, Long Short-Term Memory (LSTMs) or Gated Recurrent Units (GRUs), common components of ANNs, may perform some operations with higher or lower precision than others. For example, input gates, output gates, and/or forget gates of an LSTM may perform operations using different levels of precision—both within a given LSTM and when compared with other LSTMs.

In some configurations, different data types may be used during ANN training. For example, some portions/steps of an ANN may be processed using integer values, while other portions of the ANN may be processed using floating point values as discussed above. Precision, i.e. bit width, may similarly be mixed for these different data types. For example, some portions of some steps may be processed using int64 data types, while other portions of the same steps may be processed using int32 data types.

In some configurations, precisions (e.g. bit widths, data types, etc.) are chosen dynamically based on whether a quantization error exceeds a threshold. Quantization error may be measured at different points in an ANN network, and/or over time as training progresses, and used to determine whether to increase or decrease precision for a particular layer or for a given step or epoch

In some configurations, quantization error is calculated by comparing training results with a baseline value. Baseline values may be determined by a variety of methods, including but not limited to, training the same network using full precision floating point values, repeating a subset of the computation in high precision, and analyzing or sampling statistics of data for the computation involved. If quantization error of a portion or step exceeds a defined threshold, the precision of that portion or step may be adjusted higher to reduce the discrepancy. Similarly, different layer types (e.g. batch normalization, convolution, etc.) may have their precision adjusted based on dynamic measurement of quantization error.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that shows aspects of the configuration of a computing system disclosed herein that is capable of quantizing activations and weights during ANN training and inference, according to one embodiment disclosed herein;

FIGS. 2A and 2B are data structure diagrams showing aspects of one mechanism for using a quantized-precision floating-point format to represent weights and activation values in an ANN, according to one embodiment disclosed herein;

FIG. 3 is a block diagram that shows aspects of precision parameters used by a computing system disclosed herein for mixed precision training, according to one embodiment disclosed herein;

FIG. 4 is a neural network diagram that illustrates how nodes of an ANN might be separated into layers;

FIG. 5 is a timing diagram that illustrates epochs and steps as an ANN is trained;

FIG. 6 is a block diagram that illustrates aspects of a long short-term memory (LSTM);

FIG. 7 is a flow diagram showing a routine that illustrates aspects of an illustrative computer-implemented process for mixed precision training, according to one embodiment disclosed herein;

FIG. 8 is a computer architecture diagram showing an illustrative computer hardware and software architecture for a computing device that can implement aspects of the technologies presented herein; and

FIG. 9 is a network diagram illustrating a distributed computing environment in which aspects of the disclosed technologies can be implemented.

### DETAILED DESCRIPTION

The following detailed description is directed to technologies for mixed precision training. In addition to other technical benefits, some of which were described above, the disclosed technologies can improve the accuracy or inference time of ANNs. This can conserve computing resources including, but not limited to, memory, processor cycles, network bandwidth, and power. Other technical benefits not specifically identified herein can also be realized through implementations of the disclosed technologies.

Referring now to the drawings, in which like numerals represent like elements throughout the several FIGS., aspects of various technologies for mixed precision training will be described. In the following detailed description, references are made to the accompanying drawings that form a part hereof, and which are shown by way of illustration specific configurations or examples.

Overview of ANNs and ANN Training

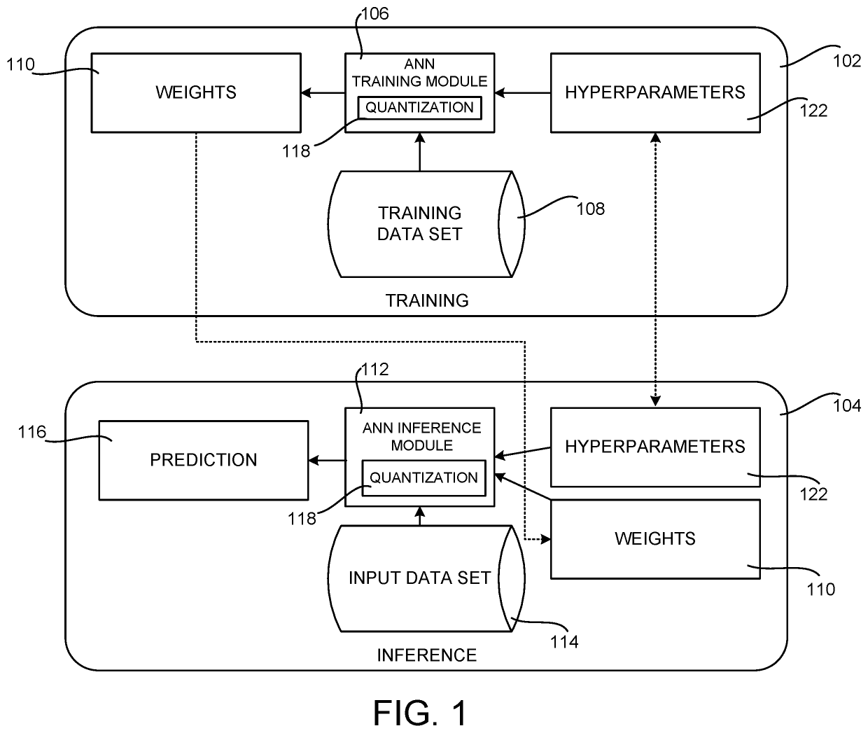

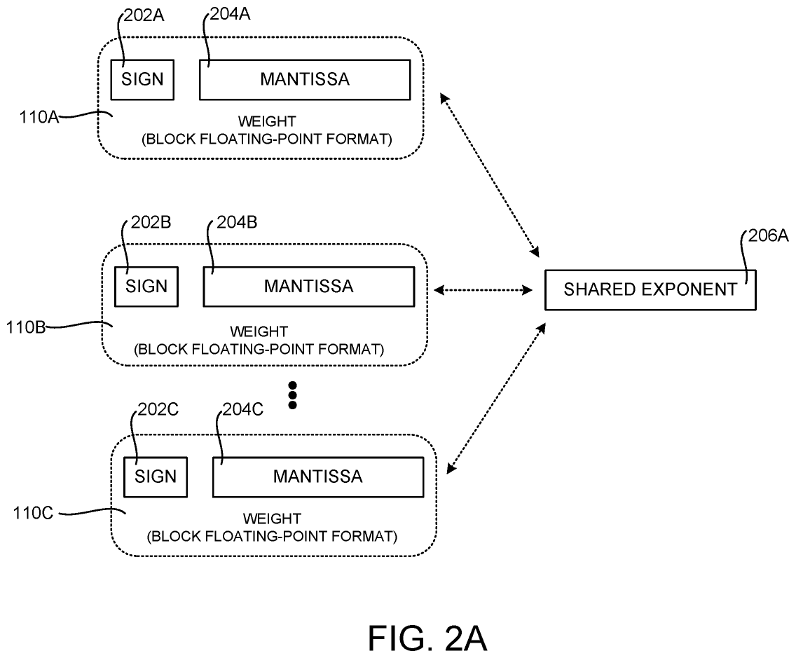

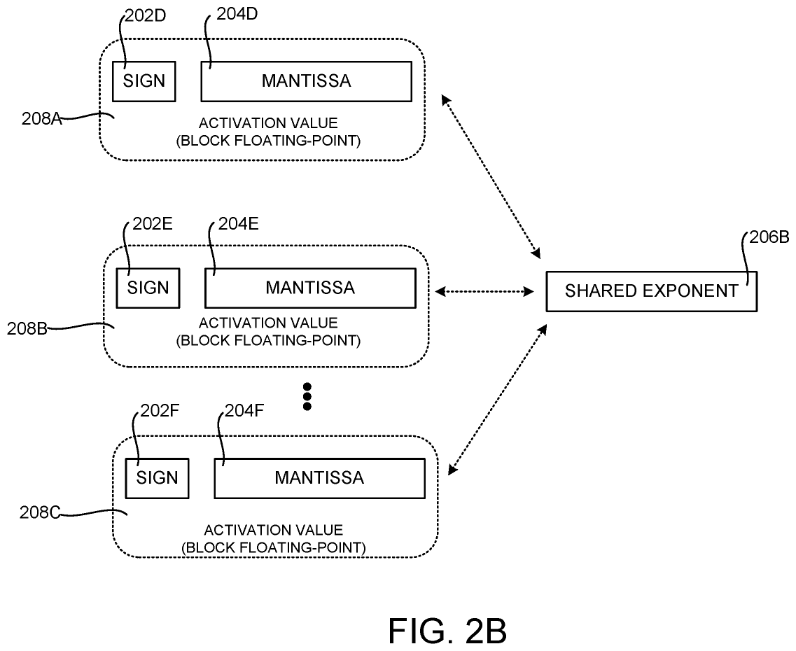

Prior to describing the disclosed technologies for mixed precision training, a brief overview of ANNs, ANN training, and quantization will be provided with reference to FIGS. 1-2B. As described briefly above, ANNs are applied to a number of applications in AI and ML including, but not limited to, recognizing images or speech, classifying images, translating speech to text and/or to other languages, facial or other biometric recognition, natural language processing (“NLP”), automated language translation, query processing in search engines, automatic content selection, analyzing email and other electronic documents, relationship management, biomedical informatics, identifying candidate biomolecules, providing recommendations, or other classification and AI tasks.

The processing for the applications described above may take place on individual devices such as personal computers or cell phones, but it might also be performed in datacenters. Hardware accelerators can also be used to accelerate ANN processing, including specialized ANN processing units, such as TPUs, FPGAs, and GPUs programmed to accelerate NN processing. Such hardware devices can be deployed in consumer devices as well as in data centers due to their flexible nature and low power consumption per unit computation.

An ANN generally consists of a sequence of layers of different types (e.g. convolution, ReLU, fully connected, and pooling layers). As shown in FIG. 1, hyperparameters 122 can define the topology of an ANN. For instance, the hyperparameters 122 can include topology parameters that define the topology, or structure, of an ANN including, but not limited to, the number and type of layers, groupings of layers, connections between the layers, and the number of filters. The hyperparameters 122 can also define other aspects of the configuration and/or operation of an ANN.

Training 102 of ANNs typically utilizes a training data set 108, i.e. when performing supervised training. The training data set 108 includes samples (e.g. images) for applying to an ANN and data describing a desired output from the ANN for each respective sample in the training data set 108 (e.g. a set of images that have been labeled with data describing the actual content in the images).

ANNs are typically trained across multiple “epochs.” In each epoch, an ANN training module 106, or another component, trains an ANN over the training data in a training data set 108 in multiple steps. In each step, the ANN first makes a prediction for an instance of the training data (which might also be referred to herein as a “sample”). This step is commonly referred to as a “forward pass” (which might also be referred to herein as a “forward training pass”).

To make a prediction, a training data sample is fed to the first layer of the ANN, which is commonly referred to as an “input layer.” Each layer of the ANN then computes a function over its inputs, often using learned parameters, or “weights 110” to produce an output (commonly referred to as an “activation”), which is used as an input for the next layer. The output of the last layer, commonly referred to as the “output layer,” is a class prediction, commonly implemented as a vector indicating the probabilities that the sample is a member of a number of classes. Based on the label predicted by the ANN and the label associated with each instance of training data in the training data set 108, the output layer computes a “loss,” or error function.

In a “backward pass” (which might also be referred to herein as a “backward training pass”) of the ANN, each layer of the ANN computes the error for the previous layer and the gradients, or updates, to the weights 110 of the layer that move the ANN's prediction toward the desired output. The result of training an ANN is a set of weights 110 that represent a transform function that can be applied to an input with the result being a prediction 116. A modelling framework such as those described below can be used to train an ANN in this manner.

ANN training may also be unsupervised—i.e. without training data set 108. Unsupervised learning may perform tasks such as masked language model, next sentence prediction, cluster analysis, and the like. Common techniques includes self-organizing maps (SOM), adaptive resonance theory (ART), etc.

After an ANN model has been trained, a component of a modelling framework (e.g. the ANN inference module 112 shown in FIG. 1) can be used during inference 104 to make a prediction 116 regarding the classification of samples in an input data set 114 that are applied to the trained ANN. Specifically, the topology of an ANN is configured using the hyperparameters 112 that were used during training 102. The ANN then uses the weights 110 (and biases) obtained during training 102 to perform classification, recognition, or other types of tasks on samples in an input data set 114, typically samples that were not used during training. Such a modelling framework can use general purpose CPUs, special purpose processors (e.g. GPUs, TPUs, or FPGAs), and other types of hardware to execute an ANN and generate predictions 116 in this way.

In some examples, proprietary or open source libraries or frameworks are utilized to facilitate ANN creation, training 102, evaluation, and inference 104. Examples of such libraries include, but are not limited to, TENSORFLOW, MICROSOFT COGNITIVE TOOLKIT (“CNTK”), CAFFE, THEANO, KERAS AND PYTORCH. In some examples, programming tools such as integrated development environments (“IDEs”) provide support for programmers and users to define, compile, and evaluate ANNs.

Tools such as those identified above can be used to define, train, and use ANNs. As one example, a modelling framework can include pre-defined application programming interfaces (“APIs”) and/or programming primitives that can be used to specify one or more aspects of an ANN, such as the hyperparameters 122. These pre-defined APIs can include both lower-level APIs (e.g., activation functions, cost or error functions, nodes, edges, and tensors) and higher-level APIs (e.g., layers, convolutional NNs, recurrent NNs, linear classifiers, and so forth).

“Source code” can be used as an input to such a modelling framework to define a topology of the graph of a given ANN. In particular, APIs of a modelling framework can be instantiated and interconnected using source code to specify a complex ANN model. Different ANN models can be defined by using different APIs, different numbers of APIs, and interconnecting the APIs in different ways. ANNs can be defined, trained, and implemented using other types of tools in other configurations.

Overview of Quantized Artificial Neural Networks

A typical floating-point representation in a computer system consists of three parts: a sign, a mantissa, and an exponent. The sign indicates if the number is positive or negative. The mantissa determines the precision to which numbers can be represented. In particular, the precision of the representation is determined by the precision of the mantissa. Common floating-point representations use a mantissa of 10 (float 16), 24 (float 32), or 53 (float64) bits in width. The exponent modifies the magnitude of the mantissa.

Traditionally, ANNs have been trained and deployed using normal-precision floating-point format (e.g. 32-bit floating-point or “float32” format) numbers. As used herein, the term “normal-precision floating-point” refers to a floating-point number format having a sign, mantissa, and a per-number exponent. Examples of normal-precision floating-point formats include, but are not limited to, IEEE 754 standard formats, such as 16-bit, 32-bit, or 64-bit formats.

Performance, energy usage, and storage requirements of ANNs can be improved through the use of quantized-precision floating-point formats during training and/or inference. In particular, weights 110 and activation values (shown in FIGS. 2A and 2B) can be represented in a lower-precision quantized-precision floating-point format, which typically results in some amount of error being introduced. Examples of quantized-precision floating-point formats include formats having a reduced bit width (including by reducing the number of bits used to represent a number's mantissa or exponent) and block floating-point (“BFP”) formats that use a small (e.g. 3, 4, or 5-bit) mantissa and an exponent shared by two or more numbers.

As shown in FIG. 1, quantization 118 can be utilized during both training 102 and inference 104. In particular, weights 110 and activation values generated by an ANN can be quantized through conversion from a normal-precision floating-point format (e.g. 16-bit or 32-bit floating point numbers) to a quantized-precision floating-point format. On certain types of hardware, such as FPGAs, the utilization of quantized-precision floating-point formats can greatly improve the latency and throughput of ANN processing.

As used herein, the term “quantized-precision floating-point” refers to a floating-point number format where two or more values of a floating-point number have been modified to have a lower precision than when the values are represented in normal-precision floating-point. In particular, some examples of quantized-precision floating-point representations include BFP formats, where two or more floating-point numbers are represented with reference to a common exponent.

A BFP format number can be generated by selecting a common exponent for two, more, or all floating-point numbers in a set and shifting mantissas of individual elements to match the shared, common exponent. Accordingly, for purposes of the present disclosure, the term “BFP” means a number system in which a single exponent is shared across two or more values, each of which is represented by a sign and mantissa pair (whether there is an explicit sign bit, or the mantissa itself is signed).

Thus, and as illustrated in FIGS. 2A and 2B, sets of floating-point numbers can be represented using a BFP floating-point format by a single shared exponent value, while each number in the set of numbers includes a sign and a mantissa. For example, and as illustrated in FIG. 2A, the weights 110A-110C generated by an ANN can each include a per-weight sign 202A-202C and a per-weight mantissa 204A-204C, respectively. However, the weights 110A-110C share a common exponent 206A. Similarly, and as shown in FIG. 2B, the activation values 208A-208C generated by an ANN can each include a per-activation value sign 202D-202F and a per-activation value mantissa 204D-204F, respectively. The activation values 208A-208C, however, share a common exponent 206B. In some examples, the shared exponent 206 for a set of BFP numbers is chosen to be the largest exponent of the original floating-point values.

Use of a BFP format, such as that illustrated in FIGS. 2A and 2B, can reduce computational resources required for certain common ANN operations. For example, for numbers represented in a normal-precision floating-point format, a floating-point addition is required to perform a dot product operation. In a dot product of floating-point vectors, summation is performed in floating-point, which can require shifts to align values with different exponents. On the other hand, for a dot product operation using BFP format floating-point numbers, the product can be calculated using integer arithmetic to combine mantissa elements. As a result, a large dynamic range for a set of numbers can be maintained with the shared exponent while reducing computational costs by using more integer arithmetic, instead of floating-point arithmetic.

BFP format floating-point numbers can be utilized to perform training operations for layers of an ANN, including forward propagation and back propagation. The values for one or more of the ANN layers can be expressed in a quantized format that has lower precision than normal-precision floating-point formats. For example, BFP formats can be used to accelerate computations performed in training and inference operations using a neural network accelerator, such as an FPGA.

Further, portions of ANN training, such as temporary storage of activation values 208, can be improved by compressing a portion of these values (e.g., for an input, hidden, or output layer of a neural network) from normal-precision floating-point to a lower-precision number format, such as BFP. The activation values 208 can be later retrieved for use during, for example, back propagation during the training phase.

As discussed above, performance, energy usage, and storage requirements of ANNs can be improved through the use of quantized-precision floating-point formats during training and/or inference. The use of quantized-precision floating-point formats in this way can, however, have certain negative impacts on ANNs such as, but not limited to, a loss in accuracy. The technologies disclosed herein address these and potentially other considerations.

Mixed Precision Training (MPT)

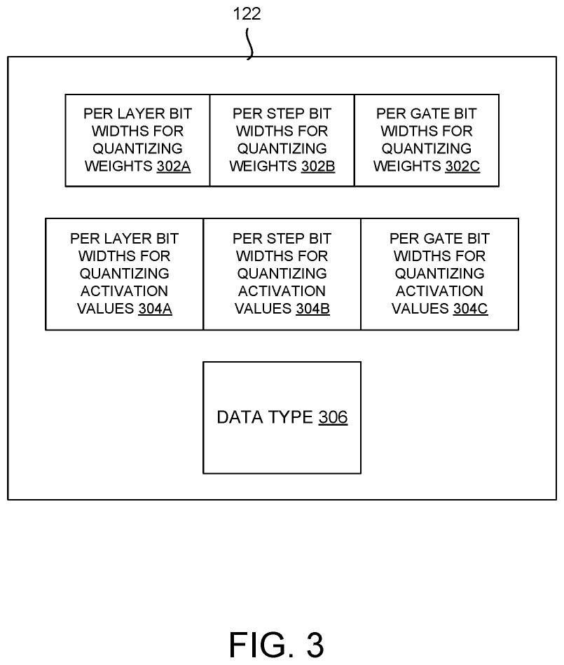

FIG. 3 is a block diagram that shows aspects of precision parameters used by a computing system disclosed herein for MPT, according to one embodiment disclosed herein. MPT generally refers to using different precisions, e.g. by using different bit widths, data types, etc., for weights, activation values, or other variables used during an ML-based process for training an ANN.

Precision may differ based on location in the ANN, i.e. precision may be different from one layer to the next. For example, an input layer may be configured to use more or less precision than a hidden layer or an output layer. Additionally, or alternatively, precision may differ across time, i.e. precision may be configured to be high or low or unchanged for different epochs or steps of the training process. In some embodiments, precision may differ within a long short-term memory (LSTM) component, e.g. an ‘input’ gate may be configured to use higher precision values than an ‘output’ gate or a ‘forget’ gate, or vice-versa.

In some configurations, the effective precision assigned to a particular node is based on a location (i.e. which layer the node is in) as well as a time (i.e. the current epoch or step). In these configurations, precision is adjusted from a baseline level (e.g. an 8 bit mantissa) according to the location, and further adjusted based on the time. For example, a node within an input layer may have its precision adjusted up. However, if training is still in an early epoch, the precision may be adjusted down. The net effect may be for the effective precision to increase, decrease, or remain unchanged from the baseline precision.

As shown in FIG. 3, hyperparameters 122 include define bit widths for weights 302, bit widths for activation values 304, and/or data type 306. Specifically, hyperparameters 122 specify per layer bit widths for quantizing weights 302A, per step bit widths for quantizing weights 302B, and per gate bit widths for quantizing weights 302C. Hyperparameters 122 also define per layer bit widths for quantizing activation values 304A, per step bit widths for quantizing activation values 304B, and per gate bit widths for quantizing activation values 304C. In some configurations, hyperparameters 122 also specify a data type 306, which indicates whether and which type of float, integer, or other data type should be used. Example data types include float32, a BFP with 5 bit mantissa, int64, or the like. Data type 306 may be configured globally for the ANN, or on a per layer/step/gate level.

In some configurations, bit widths 302 and 304 define bit widths for a mantissa 204 for storing weights/activation values generated by layers of an ANN. As discussed above, the activation values and weights can be represented using a quantized-precision floating-point format, such as a BFP format having a mantissa that has fewer bits than a mantissa in a normal-precision floating-point representation and a shared exponent. At the same time, precisions for normal-precision floating-point, non-BFP quantized representations, integers, or any other data type are similarly contemplated.

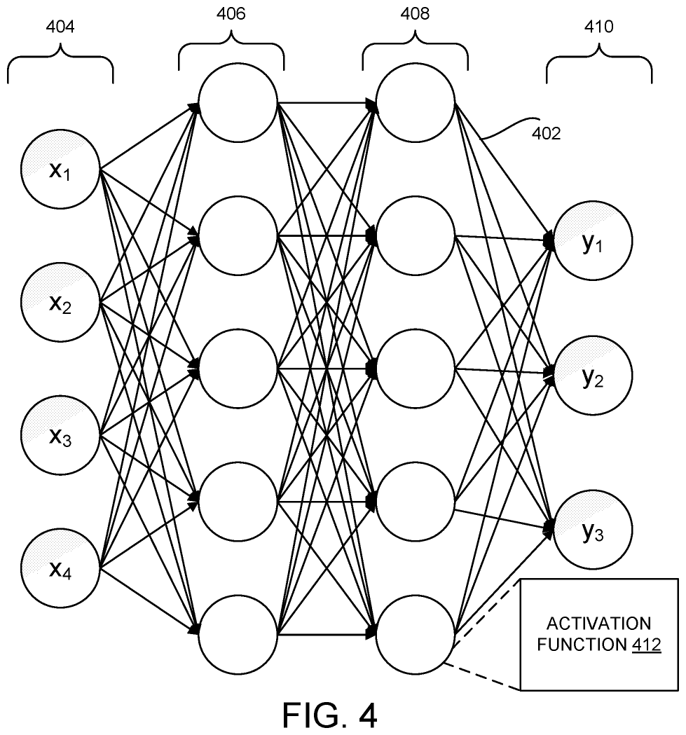

FIG. 4 is a neural network diagram that illustrates how nodes may be separated into layers (referred to more generically as ‘sets’). FIG. 4 depicts neural network 402 having layers 404, 406, 408, and 410. Layer 404 comprises an input layer, in that is receives and processes input values. Input layers are sensitive to precision, and tend to create more accurate results when higher precision (or relatively high precision) is used.

At the same time, layers 406 and 408 represent hidden layers, which do not receive input, nor do they provide output. These hidden layers can operate using lower precision without causing significant reduction in accuracy.

Layer 410 comprises an output layer, such that layer 410 provides result values (e.g. Y₁, Y₂, Y₃) that make predictions, e.g. classification, image recognition, or other ML and AI related tasks. In some configurations, output layers are sensitive to precision, and as such may be configured to process and generate values using higher levels of precision than hidden layers 406 and 408.

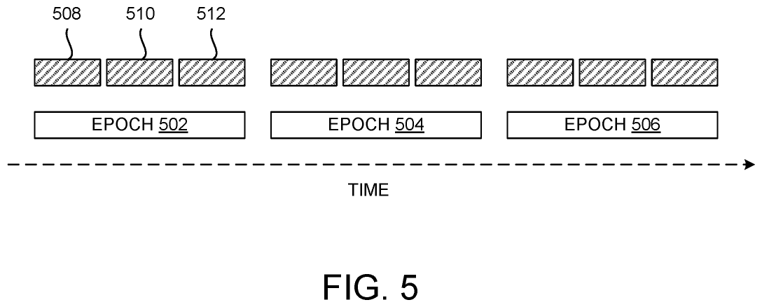

FIG. 5 is a timing diagram that illustrates epochs and steps as an ANN is trained. In this configuration, training begins in epoch 502, continues through epoch 504, and completes with epoch 506. Each epoch may perform training in any number of steps, e.g. steps 508, 510, and 512. In some configurations, each step includes forward training pass and backward training pass. While FIG. 5 depicts training over three epochs of three steps each, this breakdown is for convenience of illustration, and any number of epochs and steps are similarly contemplated. Furthermore, training may occur over a defined number of steps or an undefined number of steps—e.g. training may continue for the defined number of steps, or training may continue until a desired level of accuracy is reached.

In some configurations, each epoch, or each step, may be associated with a different precision. Activation values and weights may be set or adjusted for a specific epoch or step. For example, epoch 502 may be associated with the precision “A5W6”, which allots ‘5’ bits to activation values and ‘6’ bits to weights. Epoch 504 may seek to increase accuracy in an attempt to refine the results generated by training epoch 502. For example, the epoch 504 may be associated with the precision “A6W6”, which increases the bit width of activation values to ‘6’.

In other embodiments, successive epochs and/or steps may decrease precision or keep the same precision. In some configurations, each epoch (or step) may be associated with a change in precision. For example, a default precision may be adjusted up or down based on the current step. Other adjustments may be made on top of this adjustment, e.g. an adjustment based on the location within the ANN (e.g. based on the layer within the ANN).

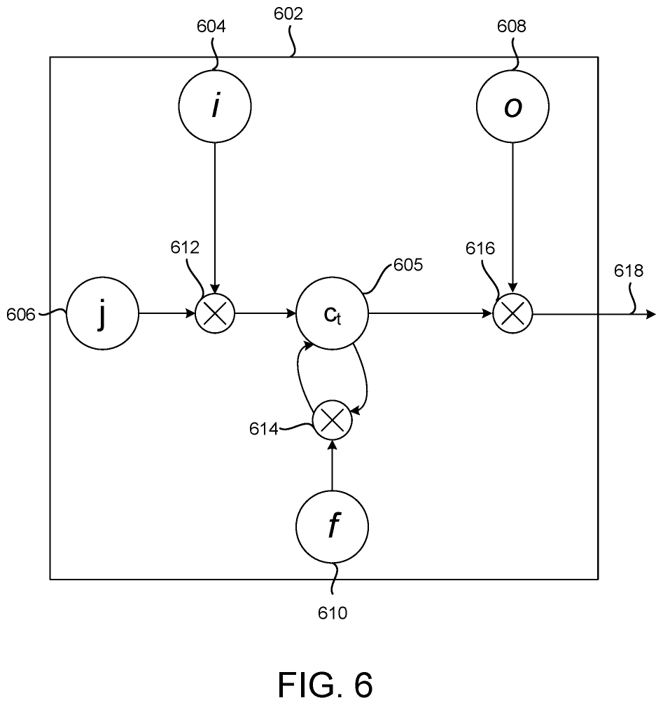

FIG. 6 is a block diagram that illustrates a long short-term memory. In some embodiments, LSTM 602 includes four gates: input gate 604, input modulation gate 606, output gate 608, and forget gate 610. LSTM 602 performs operations on values supplied to these gates, e.g. operation 612, which performs matrix multiplication on input gate 604 and input modulation gate 606, operation 614 which multiplies the value provided to the forget gate 610 with the stored cell value 605, and operation 616, which multiplies the stored cell value 605 with the value provided to the output gate 608

In some configurations, ANN training module 106 defines the precision of the operations used to perform these matrix multiplications. Different gates may be supplied with values having different levels of precision, and so matrix multiplication operations 612, 614, and 616, may each operate with and produce values of different precisions. In this way, storage and compute resources can be saved by using less precise operations on operations that are not sensitive to small bit widths.

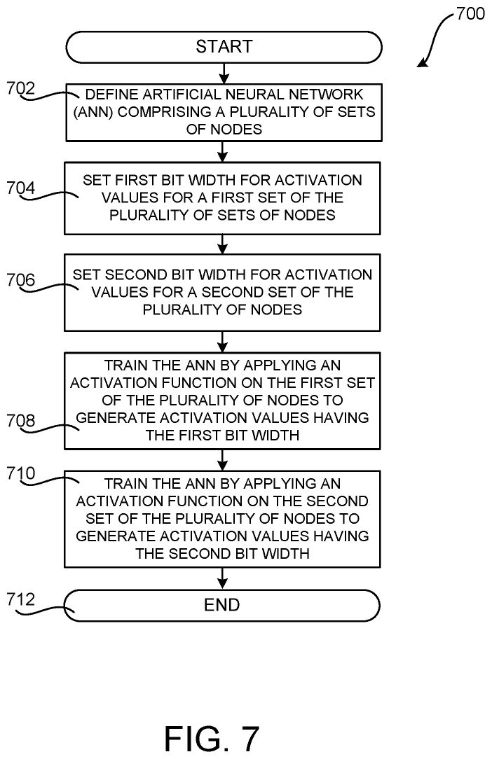

Referring now to FIG. 7, a flow diagram showing a routine 700 will be described that shows aspects of an illustrative computer-implemented process for mixed precision training. It should be appreciated that the logical operations described herein with regard to FIG. 7, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 700 begins at operation 702, where the ANN training module 106 defines an ANN that includes a number of sets of nodes. In some configurations, the sets of nodes are sets of layers as depicted in FIG. 4, such that activation values generated by one layer are supplied as inputs to another layer.

The routine 700 proceeds from operation 702 to operation 704, where the ANN training module 106 sets a first bit width for activation values associated with a first set of the plurality of sets of nodes. In some configurations, the first bit width is a default value, while in other configurations the first bit width is set based on a determination that a quantization error exceeds a threshold. For example, a quantization error may be calculated by comparing results of a potential bit width with results generated by an ANN defined using traditional floating point precision. If the difference in accuracy exceeds a defined threshold, bit width for the set of nodes may be increased. If the difference in accuracy falls below another defined threshold, bit width for the set of nodes may be decreased in order to save computing resources.

Additionally, or alternatively, quantization error may be computed or estimated by repeating only a portion of the computation in high precision. The repeated portion of the computation may be a computation over a subset of layers, steps, epochs, and/or inputs. The results of the repeated portion may be compared to results of a computation using BFP over the same, or different, subset(s) of layers, steps, epochs, and/or inputs, or over the entire ANN. Bit widths may be adjusted for the repeated portion or for the ANN as a whole.

Additionally, or alternatively, quantization error may be computed or estimated by sampling statistics throughout the computation, and determining to increase or decrease bit width in response to changes in the statistics. In some configurations, statistics such as accuracy, training speed, training efficiency, and the like may be tracked over time, and a moving average computed. During training, periodically sampled statistics may be compared to the moving average, and bit widths may be adjusted in response to sampled statistics exceeding or falling below the moving average by a defined threshold. For example, bit widths may be lowered when accuracy falls beneath an accuracy moving average by a defined threshold. In some configurations, bit widths may be adjusted in response to a large, rapid, and/or unexpected (i.e. unexpected for a particular layer, step, epoch) change to a moving average. Bit width changes may be for a corresponding layer, step, epoch, etc., or to the ANN as a whole.

In some configurations, bit width is set to balance accuracy requirements with storage and compute costs. However, bit width may be set to maximize accuracy, minimize storage and compute costs, or a combination thereof. In some configurations, the ANN training module 106 also sets a data type used to perform ANN training operations and which is used to store the results of ANN training operations (e.g. weights). The routine 700 then proceeds from operation 704 to operation 706.

At operation 706, ANN training module 106 sets a second bit width for activation values for a second set of the plurality of sets of nodes. The second bit width may be determined using the techniques described above with regard to operation 704. In some configurations, the first bit width and the second bit width are different, e.g. the first bit width defines a 6-bit mantissa, while the second bit width defines a 5-bit mantissa.

The routine 700 then proceeds from operation 706 to operation 708, where ANN training module 106 trains the ANN in part by applying a first activation function to the first set of the plurality of sets of nodes. In some configurations, the first activation function produces activation values having the first bit width. Additionally, or alternatively, the result of the first activation function is compressed (also referred to as quantized) into a precision defined by the first bit width.

The routine 700 then proceeds from operation 708 to operation 710, where ANN training module 106 trains the ANN in part by applying a second activation function to the second set of the plurality of sets of nodes. In some configurations, the second activation function produces activation values having the second bit width. Additionally, or alternatively, the result of the second activation function is compressed (also referred to as quantized) into a precision defined by the second bit width. In some configurations, the first and second activation functions are the same function, with only the bit width (and any input values) changing.

The routine 700 then proceeds from operation 710 to operation 712, where it ends.

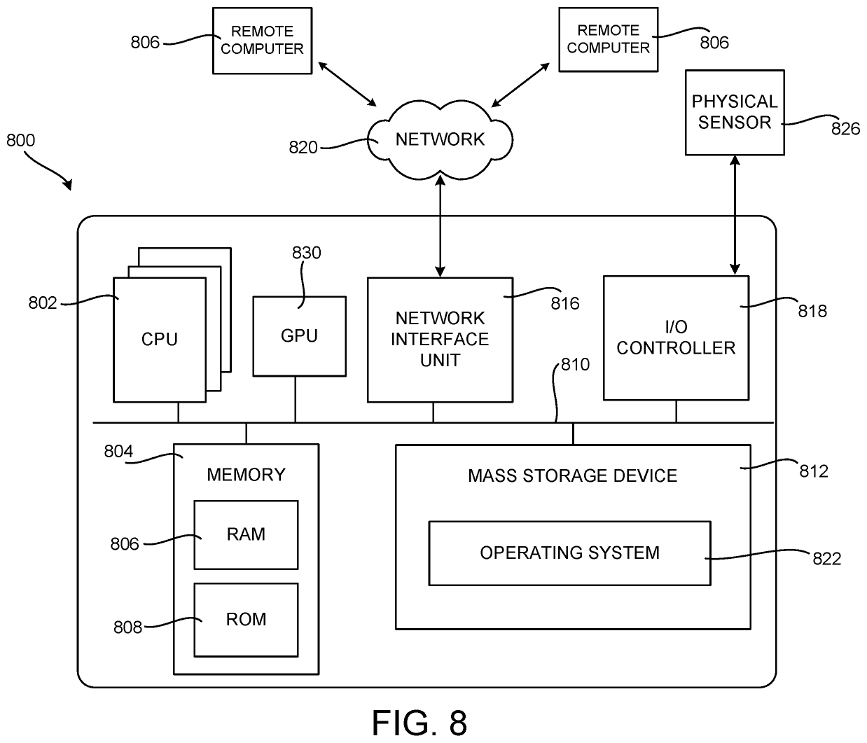

FIG. 8 is a computer architecture diagram showing an illustrative computer hardware and software architecture for a computing device that can implement the various technologies presented herein. In particular, the architecture illustrated in FIG. 8 can be utilized to implement a server computer, mobile phone, an e-reader, a smartphone, a desktop computer, an alternate reality or virtual reality (“AR/VR”) device, a tablet computer, a laptop computer, or another type of computing device.

While the subject matter described herein is presented in the general context of server computers performing training of an ANN, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

The computer 800 illustrated in FIG. 8 includes one or more central processing units 802 (“CPU”), one or more GPUs 830, a system memory 804, including a random-access memory 806 (“RAM”) and a read-only memory (“ROM”) 808, and a system bus 810 that couples the memory 804 to the CPU 802. A basic input/output system (“BIOS” or “firmware”) containing the basic routines that help to transfer information between elements within the computer 800, such as during startup, can be stored in the ROM 808. The computer 800 further includes a mass storage device 812 for storing an operating system 822, application programs, and other types of programs. The mass storage device 812 can also be configured to store other types of programs and data.

The mass storage device 812 is connected to the CPU 802 through a mass storage controller (not shown) connected to the bus 810. The mass storage device 812 and its associated computer readable media provide non-volatile storage for the computer 800. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 800. For purposes of the claims, the phrase “computer storage medium,” and variations thereof, does not include waves or signals per se or communication media.

According to various configurations, the computer 800 can operate in a networked environment using logical connections to remote computers through a network such as the network 820. The computer 800 can connect to the network 820 through a network interface unit 816 connected to the bus 810. It should be appreciated that the network interface unit 816 can also be utilized to connect to other types of networks and remote computer systems. The computer 800 can also include an input/output controller 818 for receiving and processing input from a number of other devices, including a keyboard, mouse, touch input, an electronic stylus (not shown in FIG. 8), or a physical sensor such as a video camera. Similarly, the input/output controller 818 can provide output to a display screen or other type of output device (also not shown in FIG. 8).

It should be appreciated that the software components described herein, when loaded into the CPU 802 and executed, can transform the CPU 802 and the overall computer 800 from a general-purpose computing device into a special-purpose computing device customized to facilitate the functionality presented herein. The CPU 802 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 802 by specifying how the CPU 802 transitions between states, thereby transforming the transistors or other discrete hardware elements constituting the CPU 802.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer storage media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 800 in order to store and execute the software components presented herein. It also should be appreciated that the architecture shown in FIG. 8 for the computer 800, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 800 might not include all of the components shown in FIG. 8, can include other components that are not explicitly shown in FIG. 8, or can utilize an architecture completely different than that shown in FIG. 8.

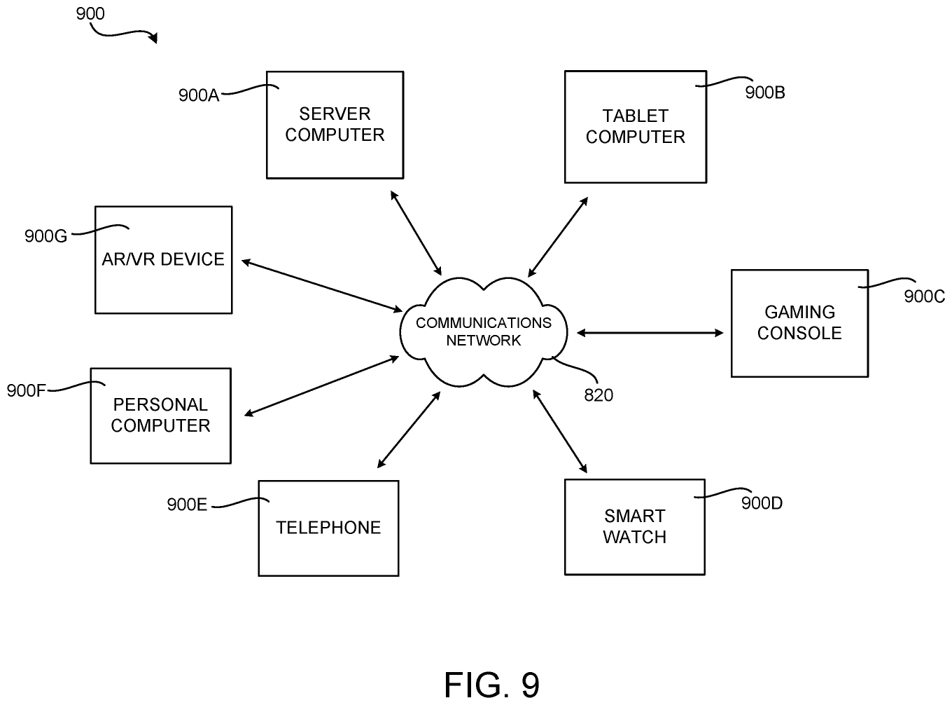

FIG. 9 is a network diagram illustrating a distributed network computing environment 900 in which aspects of the disclosed technologies can be implemented, according to various configurations presented herein. As shown in FIG. 9, one or more server computers 900A can be interconnected via a communications network 820 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 900B, a gaming console 900C, a smart watch 900D, a telephone 900E, such as a smartphone, a personal computer 900F, and an AR/VR device 900G.

In a network environment in which the communications network 820 is the Internet, for example, the server computer 900A can be a dedicated server computer operable to process and communicate data to and from the client computing devices 900B-900G via any of a number of known protocols, such as, hypertext transfer protocol (“HTTP”), file transfer protocol (“FTP”), or simple object access protocol (“SOAP”). Additionally, the networked computing environment 900 can utilize various data security protocols such as secured socket layer (“SSL”) or pretty good privacy (“PGP”). Each of the client computing devices 900B-900G can be equipped with an operating system operable to support one or more computing applications or terminal sessions such as a web browser (not shown in FIG. 9), other graphical user interface (not shown in FIG. 9), or a mobile desktop environment (not shown in FIG. 9) to gain access to the server computer 900A.

The server computer 900A can be communicatively coupled to other computing environments (not shown in FIG. 9) and receive data regarding a participating user's interactions/resource network. In an illustrative operation, a user (not shown in FIG. 9) may interact with a computing application running on a client computing device 900B-900G to obtain desired data and/or perform other computing applications.

The data and/or computing applications may be stored on the server 900A, or servers 900A, and communicated to cooperating users through the client computing devices 900B-900G over an exemplary communications network 820. A participating user (not shown in FIG. 9) may request access to specific data and applications housed in whole or in part on the server computer 900A. This data may be communicated between the client computing devices 900B-900G and the server computer 900A for processing and storage.

The server computer 900A can host computing applications, processes and applets for the generation, authentication, encryption, and communication of data and applications, and may cooperate with other server computing environments (not shown in FIG. 9), third party service providers (not shown in FIG. 9), network attached storage (“NAS”) and storage area networks (“SAN”) to realize application/data transactions.

It should be appreciated that the computing architecture shown in FIG. 9 and the distributed network computing environment shown in FIG. 9 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following examples:

Example 1: A computer-implemented method, comprising: defining an artificial neural network (ANN) comprising a plurality of layers of nodes; setting a first bit width for activation values associated with a first layer of the plurality of layers of nodes; setting a second bit width for activation values associated with a second layer of the plurality of layers of nodes; and during training of or inference from the ANN, applying a first activation function to the first layer of the plurality of layers of nodes, thereby generating a plurality activation values having the first bit width, and applying a second activation function to the second layer of the plurality of layers of nodes, thereby generating a second plurality of activation values having the second bit width.

Example 2: The computer-implemented method of Example 1, further comprising: setting a third bit width for weights associated with the first layer of the plurality of layers of nodes, wherein during training of or inference from the ANN, the first layer of the plurality of layers of nodes generates weights having the third bit width; and setting a fourth bit width for weights associated with the second layer of the plurality of layers of nodes, wherein during training of or inference from the ANN, the second layer of the plurality of layers of nodes generates weights having the fourth bit width.

Example 3: The computer-implemented method of Example 1, wherein the first layer of the plurality of layers of nodes comprises an input layer, wherein the second layer of the plurality of layers of nodes comprises an output layer, and wherein the first bit width and the second bit width are set to be different from bit widths associated with a set of remaining layers of nodes.

Example 4: The computer-implemented method of Example 1, wherein the ANN is trained or an inference is made from the ANN over a plurality of steps, wherein the first bit width is used to train or infer from the first layer of the plurality of layers of nodes during a first of the plurality of steps, and wherein a fifth bit width is used to train or infer from the first layer of the plurality of layers of nodes during a second of the plurality of steps.

Example 5: The computer-implemented method of Example 4, wherein an effective bit width is determined for the first layer during the first of the plurality of steps by averaging a bit width associated with the first layer and a bit width associated with the first of the plurality of steps.

Example 6: The computer-implemented method of Example 1, further comprising: setting a sixth bit width for a first gate type of a long short-term memory (LSTM) component of the ANN; and setting a seventh bit width for a second gate type of the LSTM component of the ANN.

Example 7: The computer-implemented method of Example 1, wherein the activation values are represented in a block floating-point format (BFP) having a mantissa comprising fewer bits than a mantissa in a normal-precision floating-point representation.

Example 8: A computer-implemented method, comprising: defining an artificial neural network (ANN) comprising a plurality of layers of nodes, wherein the ANN is trained over a plurality of steps; setting a first bit width for activation values generated during a first step of the plurality of steps; setting a second bit width for activation values generated during a second step of the plurality of steps; training the ANN by applying a first activation function during the first step of the plurality of steps, thereby generating activation values having the first bit width; and training the ANN by applying a second activation function during the second step of the plurality of steps, thereby generating activation values having the second bit width.

Example 9: The computer-implemented method of Example 8, wherein the ANN is trained over a plurality of epochs, wherein the first bit width is set for values generated during a first epoch, and wherein the second bit width is set for values generated during a second epoch.

Example 10: The computer-implemented method of Example 9, wherein the first bit width is different from the second bit width.

Example 11: The computer-implemented method of Example 8, wherein a third bit width is associated with a first layer of a plurality of layers of nodes, wherein a fourth bit width is associated with a second layer of a plurality of layers of nodes, and wherein an effective bit width for nodes in the first layer and that are trained during the first step is based on a combination of the first bit width and the third bit width.

Example 12: The computer-implemented method of Example 11, wherein the effective bit width for nodes in the first layer and that are trained during the first step is determined by increasing the first bit width when the third bit width is greater than the first bit width, and decreasing the first bit width when the third bit width is lower than the first bit width.

Example 13: The computer-implemented method of Example 8, wherein the first bit width or the second bit width are dynamically updated during training when a quantization error exceeds or falls below a defined threshold.

Example 14: The computer-implemented method of Example 8, further comprising: inferring an output from the trained ANN over the plurality of steps, the inferring including: applying the first activation function during the first step of the plurality of steps; and applying the second activation function during the second step of the plurality of steps.

Example 15: A computing device, comprising: one or more processors; and at least one computer storage media having computer-executable instructions stored thereupon which, when executed by the one or more processors, will cause the computing device to: define an artificial neural network (ANN) comprising one or more components that comprise a plurality of gates; set a first bit width for a first of the plurality of gates; set a second bit width for a second of the plurality of gates; and infer an output from the ANN in part by processing inputs supplied to the plurality of gates, wherein inputs supplied to the first of the plurality of gates are processed using the first bit width and wherein inputs supplied to the second of the plurality of gates are processed using the second bit width.

Example 16: The computing device of Example 15, wherein the one or more components comprise one or more long short-term memory components (LSTMs), wherein the LSTM comprises a j gate, an i gate, an f gate, and an o gate, and wherein the j gate is assigned different bit width than the other gates.

Example 17: The computing device of Example 16, wherein the first of the plurality of gates comprises an input gate, and wherein the second of the plurality of gates comprises an output gate.

Example 18: The computing device of Example 17, wherein the first bit width is different from the second bit width.

Example 19: The computing device of Example 15, wherein the ANN is trained over a plurality of steps, and wherein the first bit width is adjusted across the plurality of steps as the ANN is trained.

Example 20: The computing device of Example 15, wherein the one or more components comprise one or more long short-term memory components (LSTMs) or gated recurrent units (GRUs).

Based on the foregoing, it should be appreciated that technologies for mixed precision training have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
defining an artificial neural network (ANN) comprising a plurality of layers of nodes;
setting a first bit width for activation values associated with a first layer of the plurality of layers of nodes;
setting a second bit width for activation values associated with a second layer of the plurality of layers of nodes; and
during training of or inference from the ANN,
applying a first activation function to the first layer of the plurality of layers of nodes, thereby generating a plurality activation values having the first bit width, and
applying a second activation function to the second layer of the plurality of layers of nodes, thereby generating a second plurality of activation values having the second bit width.

2. The computer-implemented method of claim 1, further comprising:
setting a third bit width for weights associated with the first layer of the plurality of layers of nodes, wherein during training of or inference from the ANN, the first layer of the plurality of layers of nodes generates weights having the third bit width; and
setting a fourth bit width for weights associated with the second layer of the plurality of layers of nodes, wherein during training of or inference from the ANN, the second layer of the plurality of layers of nodes generates weights having the fourth bit width.

3. The computer-implemented method of claim 1, wherein the first layer of the plurality of layers of nodes comprises an input layer, wherein the second layer of the plurality of layers of nodes comprises an output layer, and wherein the first bit width and the second bit width are set to be different from bit widths associated with a set of remaining layers of nodes.

4. The computer-implemented method of claim 1, wherein the ANN is trained or an inference is made from the ANN over a plurality of steps, wherein the first bit width is used to train or infer from the first layer of the plurality of layers of nodes during a first of the plurality of steps, and wherein a fifth bit width is used to train or infer from the first layer of the plurality of layers of nodes during a second of the plurality of steps.

5. The computer-implemented method of claim 4, wherein an effective bit width is determined for the first layer during the first of the plurality of steps by averaging a bit width associated with the first layer and a bit width associated with the first of the plurality of steps.

6. The computer-implemented method of claim 1, further comprising:
setting a sixth bit width for a first gate type of a long short-term memory (LSTM) component of the ANN; and
setting a seventh bit width for a second gate type of the LSTM component of the ANN.

7. The computer-implemented method of claim 1, wherein the activation values are represented in a block floating-point format (BFP) having a mantissa comprising fewer bits than a mantissa in a normal-precision floating-point representation.

8. A computer-implemented method, comprising:
defining an artificial neural network (ANN) comprising a plurality of layers of nodes, wherein the ANN is trained over a plurality of steps;
setting a first bit width for activation values generated during a first step of the plurality of steps;
setting a second bit width for activation values generated during a second step of the plurality of steps;
training the ANN by applying a first activation function during the first step of the plurality of steps, thereby generating activation values having the first bit width; and
training the ANN by applying a second activation function during the second step of the plurality of steps, thereby generating activation values having the second bit width.

9. The computer-implemented method of claim 8, wherein the ANN is trained over a plurality of epochs, wherein the first bit width is set for values generated during a first epoch, and wherein the second bit width is set for values generated during a second epoch.

10. The computer-implemented method of claim 9, wherein the first bit width is different from the second bit width.

11. The computer-implemented method of claim 8, wherein a third bit width is associated with a first layer of a plurality of layers of nodes, wherein a fourth bit width is associated with a second layer of a plurality of layers of nodes, and wherein an effective bit width for nodes in the first layer and that are trained during the first step is based on a combination of the first bit width and the third bit width.

12. The computer-implemented method of claim 11, wherein the effective bit width for nodes in the first layer and that are trained during the first step is determined by increasing the first bit width when the third bit width is greater than the first bit width, and decreasing the first bit width when the third bit width is lower than the first bit width.

13. The computer-implemented method of claim 8, wherein the first bit width or the second bit width are dynamically updated during training when a quantization error exceeds or falls below a defined threshold.

14. The computer-implemented method of claim 8, further comprising:
inferring an output from the trained ANN over the plurality of steps, the inferring including:
applying the first activation function during the first step of the plurality of steps; and
applying the second activation function during the second step of the plurality of steps.

15. A computing device, comprising:
one or more processors; and
at least one computer storage media having computer-executable instructions stored thereupon which, when executed by the one or more processors, will cause the computing device to:
define an artificial neural network (ANN) comprising one or more components that comprise a plurality of gates;
set a first bit width for a first of the plurality of gates;
set a second bit width for a second of the plurality of gates; and
infer an output from the ANN in part by processing inputs supplied to the plurality of gates, wherein inputs supplied to the first of the plurality of gates are processed using the first bit width and wherein inputs supplied to the second of the plurality of gates are processed using the second bit width.

16. The computing device of claim 15, wherein the one or more components comprise one or more long short-term memory components (LSTMs), wherein the LSTM comprises a j gate, an i gate, an f gate, and an o gate, and wherein the j gate is assigned different bit width than the other gates.

17. The computing device of claim 16, wherein the first of the plurality of gates comprises an input gate, and wherein the second of the plurality of gates comprises an output gate.

18. The computing device of claim 17, wherein the first bit width is different from the second bit width.

19. The computing device of claim 15, wherein the ANN is trained over a plurality of steps, and wherein the first bit width is adjusted across the plurality of steps as the ANN is trained.

20. The computing device of claim 15, wherein the one or more components comprise one or more long short-term memory components (LSTMs) or gated recurrent units (GRUs).
